(19) United States
(12) Patent Application Publication
(10) Pub. No.: US 2026/0302033 A1
(43) Pub. Date: Oct. 1, 2026

(54) COIL COMPONENT

(71) Applicant: TDK Corporation, Tokyo (JP)

(72) Inventors: Yuma USAMI, Tokyo (JP); Hokuto EDA, Tokyo (JP); Kohei TAKAHASHI, Tokyo (JP); Takahiro NEMOTO, Tokyo (JP); Ryota ISHIKAWA, Tokyo (JP)

(73) Assignee: TDK Corporation, Tokyo (JP)

(21) Appl. No.: 19/578,996

(22) Filed: Mar. 26, 2026

(30) Foreign Application Priority Data
Mar. 28, 2025 (JP) 2025-056556

(51) Int. Cl. H01F 17/00; H01F 17/04; H01F 27/29; H01F 27/32

(52) U.S. Cl. CPC H01F 17/0013; H01F 27/292; H01F 27/324; H01F 2017/002; H01F 2017/0073; H01F 2017/048

(57) ABSTRACT

In a coil component, an outer end portion of a second coil portion of a first coil provided on a lower surface of a substrate and an outer end portion of a first coil portion of a second coil provided on an upper surface of the substrate are connected via a second through-hole conductor, whereby, when considering a current path, only the second coil portion of the first coil is interposed between an adjacent first coil portion of the first coil and first coil portion of the second coil on the upper surface of the substrate, and thus a potential difference between the first coil portions is reduced, thereby suppressing a situation in which a large stray capacitance is generated in a gap between the first coil portions.

### CROSS-REFERENCE TO RELATED APPLICATIONS

This application is based upon and claims the benefit of priority from Japanese Patent Application No. 2025-56556, filed on 28 Mar. 2025, the entire contents of which are incorporated herein by reference.

### TECHNICAL FIELD

The present disclosure relates to a coil component.

### BACKGROUND

Well known in the art is a coil component including a thin-film coil used in a power supply circuit. Japanese Unexamined Patent Application Publication No. 2017-34227 discloses a thin-film coil having a configuration in which a first coil portion spirally wound on one surface of a substrate and a second coil portion spirally wound on the other surface of the substrate are connected via a through-hole conductor provided through the substrate.

### SUMMARY

In recent years, development of a technology (PoC: Power over Coax) for superimposing power and a signal on a single coaxial cable has been advanced, and a coil component used for this technology is required to have high impedance over a wide range from a low band to a high band in order to achieve high signal transmission characteristics.

The inventors have obtained a finding that in order to realize high impedance over a wide range from a low band to a high band, it is effective to reduce the stray capacitance of the coil component and increase the self-resonant frequency (SRF).

According to various aspects of the present disclosure, a coil component with reduced stray capacitance is provided.

A coil component according to one aspect of the present disclosure includes an element body, a substrate provided in the element body and having a first main surface and a second main surface parallel to each other, a coil body provided in the element body, the coil body having a first coil and a second coil arranged in a first direction, each of the first coil and the second coil including a first coil portion spirally wound on the first main surface of the substrate, a second coil portion spirally wound on the second main surface of the substrate, and a through-hole conductor provided through the substrate to electrically connect inner end portions of the first coil portion and the second coil portion to each other, and a second through-hole conductor provided through the substrate to electrically connect an outer end portion of the second coil portion of the first coil and an outer end portion of the first coil portion of the second coil to each other.

### BRIEF DESCRIPTION OF THE DRAWINGS

FIG. 1 is a perspective view showing a coil component according to an embodiment.

FIG. 2 is an exploded perspective view of the coil component shown in FIG. 1.

FIG. 3 is an exploded perspective view showing a coil body provided in the element body shown in FIG. 2.

FIG. 4 is a cross-sectional view showing a configuration of the coil shown in FIG. 3.

FIG. 5 is a plan view showing a first coil portion of each coil shown in FIG. 3.

FIG. 6 is a plan view showing a second coil portion of each coil shown in FIG. 3.

FIG. 7 is an exploded perspective view of a coil component for comparison.

FIG. 8 is a plan view showing a first coil portion of each coil in a form different from that of FIG. 5.

FIG. 9 is a plan view showing a second coil portion of each coil in a form different from that of FIG. 6.

### DETAILED DESCRIPTION

Hereinafter, embodiments for carrying out the present disclosure will be described with reference to the accompanying drawings. In the description of the drawings, the same reference numerals are used for the same or equivalent elements, and redundant description is omitted.

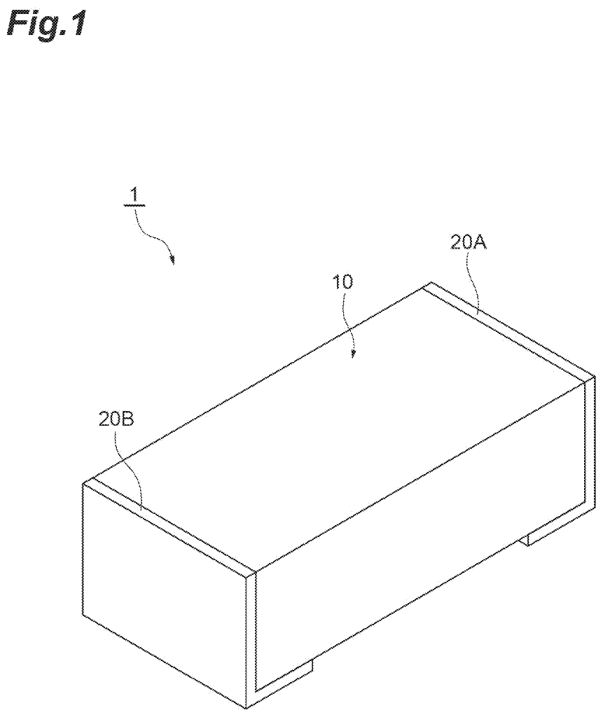

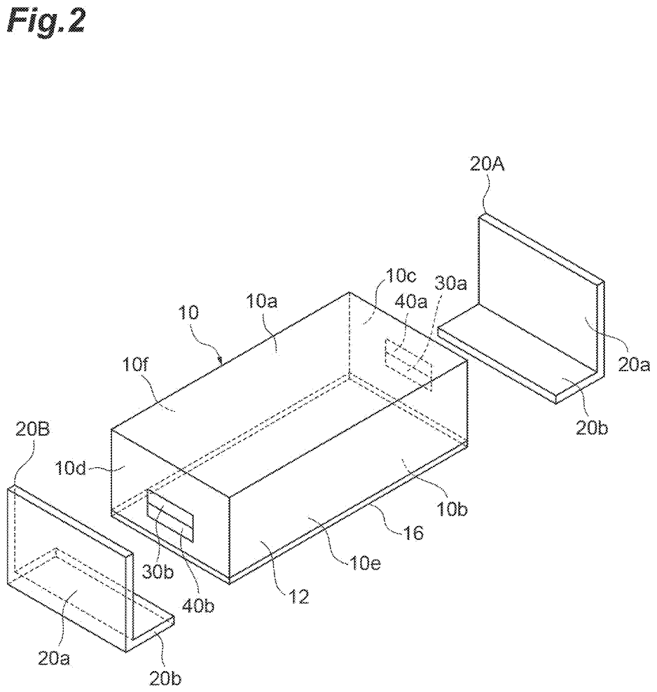

A coil component 1 according to one embodiment will be described with reference to FIGS. 1 to 6. As shown in FIGS. 1 and 2, the coil component 1 is configured to include an element body 10 and a pair of external terminals 20A and 20B provided on a surface of the element body 10.

The element body 10 has a substantially rectangular parallelepiped outer shape, and has a pair of main surfaces 10a and 10b facing each other, a pair of end surfaces 10c and 10d facing each other, and a pair of side surfaces 10e and 10f facing each other. The pair of end surfaces 10c and 10d and the pair of side surfaces 10e and 10f connect the pair of main surfaces 10a and 10b. In the present embodiment, a facing direction of the pair of main surfaces 10a and 10b is a height direction of the element body 10, a facing direction of the pair of end surfaces 10c and 10d is a long-side direction of the element body 10, and a facing direction of the pair of side surfaces 10e and 10f is a short-side direction of the element body 10. In the present embodiment, the main surface 10b is a mounting surface that faces a base material on which the coil component 1 is mounted. The coil component 1 is designed, as an example, with dimensions of a long side of 2.0 mm, a short side of 1.25 mm, and a height of 1.0 mm.

Of the pair of external terminals 20A and 20B, a first external terminal 20A is provided on a side of an end surface 10c (a first end surface) of the element body 10. The first external terminal 20A includes a portion 20a that covers the end surface 10c and a portion 20b that covers a part of the main surface 10b on the end surface 10c side, and has an L-shaped cross section that continuously covers the end surface 10c and the main surface 10b. Of the pair of external terminals 20A and 20B, a second external terminal 20B is provided on a side of an end surface 10d (a second end surface) of the element body 10. The second external terminal 20B, similar to the first external terminal 20A, includes a portion 20a that covers the end surface 10d and a portion 20b that covers a part of the main surface 10b on the end surface 10d side, and has an L-shaped cross section that continuously covers the end surface 10d and the main surface 10b.

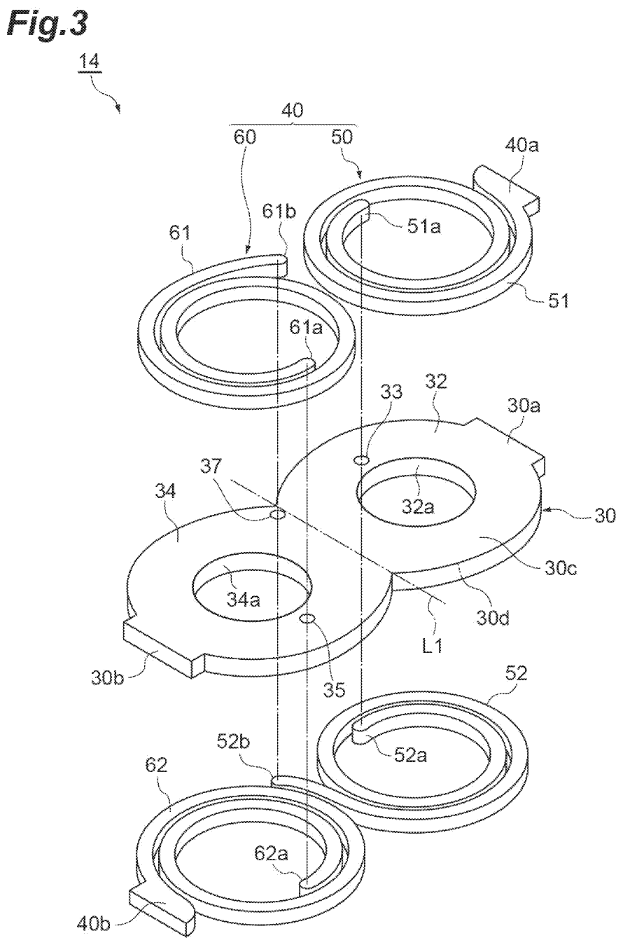

The element body 10 has a configuration in which a coil structure 14 shown in FIG. 3 is provided inside a magnetic material 12. A magnetic powder-containing resin can be used for the magnetic material 12 that constitutes the element body 10. The magnetic powder-containing resin has a configuration in which magnetic powder such as metal magnetic powder or ferrite powder is dispersed in a resin. The magnetic powder-containing resin may contain both metal magnetic powder and ferrite powder as the magnetic powder. The metal magnetic powder may be composed of, for example, an iron-nickel alloy (Permalloy alloy), carbonyl iron, an amorphous, non-crystalline or crystalline FeSiCr-based alloy, Sendust, or the like. The resin used for the magnetic powder-containing resin is, for example, a thermosetting epoxy resin. The content of the magnetic powder contained in the magnetic powder-containing resin is, for example, 90 to 99 wt %. In the present embodiment, only the main surface 10b of the element body 10 is configured with an insulating layer 16 made of an insulating material such as an insulating resin (for example, an epoxy resin) instead of the magnetic powder-containing resin. Although the portions 20b of the pair of external terminals 20A and 20B are close to each other on the main surface 10b, the insulating layer 16 improves the breakdown voltage between the pair of external terminals 20A and 20B on the main surface 10b. In addition, on the main surface 10b, since the insulating material of the insulating layer 16 is interposed between each of the external terminals 20A and 20B and the magnetic powder-containing resin (that is, each of the external terminals 20A and 20B does not directly contact the magnetic powder-containing resin), a reduction in stray capacitance is also achieved. The element body 10 may have a configuration that does not include the insulating layer 16, or may have an aspect configured only with the magnetic powder-containing resin.

The coil structure 14 is configured to include a substrate 30 and a coil body 40.

The substrate 30 extends between the pair of end surfaces 10c and 10d of the element body 10, and has end portions 30a and 30b exposed from the respective end surfaces 10c and 10d. The substrate 30 has a flat plate shape extending parallel to the main surfaces 10a and 10b of the element body 10, and has an upper surface (first main surface) 30c located on the main surface 10a side and a lower surface (second main surface) 30d located on the main surface 10b side. The substrate 30 has a first portion 32 corresponding to a first coil 50 and a second portion 34 corresponding to a second coil 60, which will be described later, and through-holes 32a and 34a are provided in the first portion 32 and the second portion 34, respectively. In the present embodiment, the substrate 30 has a figure-eight shape when viewed from the main surface 10a side of the element body 10, and the shapes and dimensions of the plurality of through-holes 32a and 34a provided in the substrate 30 have a line-symmetrical relationship with respect to a reference line L1 parallel to the end surfaces 10c and 10d of the element body 10.

The substrate 30 is made of a non-magnetic insulating material. For the substrate 30, a substrate in which glass cloth is impregnated with a cyanate resin (BT (bismaleimide-triazine) resin: registered trademark) can be used. In addition, besides the BT resin, polyimide, aramid, or the like can also be used. As a material for the substrate 30, ceramic or glass can also be used. As a material for the substrate 30, a mass-produced printed circuit board material can be used, and a resin material used for a BT printed circuit board, an FR4 printed circuit board, or an FR5 printed circuit board can be used.

The coil body 40 includes two coils, a first coil 50 and a second coil 60, arranged in the long-side direction (first direction) of the element body 10. The first coil 50 and the second coil 60 are connected in series. One end portion 40a of the coil body 40 is exposed on the end surface 10c of the element body 10 on the upper surface 30c of the substrate 30 and is connected to the first external terminal 20A. The other end portion 40b of the coil body 40 is exposed on the end surface 10d of the element body 10 on the lower surface 30d of the substrate 30 and is connected to the second external terminal 20B.

Each of the coils 50 and 60 included in the coil body 40 includes first coil portions 51 and 61 spirally wound on the upper surface 30c of the substrate 30, second coil portions 52 and 62 spirally wound on the lower surface 30d of the substrate 30, first through-hole conductors 33 and 35 provided through the substrate 30 to electrically connect inner end portions 51a, 52a, 61a, and 62a of the first coil portions 51 and 61 and the second coil portions 52 and 62 to each other, and a second through-hole conductor 37 provided through the substrate 30 to electrically connect an outer end portion 52b of the second coil portion 52 of the first coil 50 and an outer end portion 61b of the first coil portion 61 of the second coil 60 to each other.

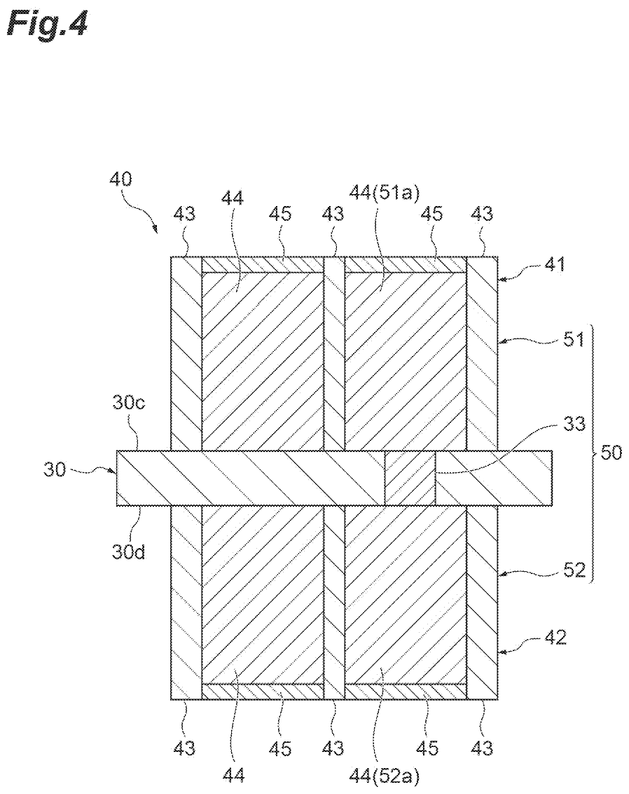

As shown in FIG. 4, resin bodies 41 and 42 are provided on the upper surface 30c and the lower surface 30d of the substrate 30, respectively, and a region of a conductor 44 constituting the coil body 40 is defined by resin walls 43 of the resin bodies 41 and 42. Specifically, the resin wall 43 of the resin body 41 (first resin body) provided on the upper surface 30c of the substrate 30 covers the first coil portions 51 and 61 at an inner periphery, an outer periphery, and between lines thereof. In the present embodiment, as shown in FIG. 4, a width of the resin wall 43 of the first resin body 41 at the outer periphery and the inner periphery of the first coil portions 51 and 61 is designed to be wider than a width of the resin wall 43 of the first resin body 41 between the lines of the first coil portions 51 and 61. The width of the resin wall 43 of the first resin body 41 at the outer periphery of the first coil portions 51 and 61 may be wider than or the same as the width of the resin wall 43 of the first resin body 41 at the inner periphery. As an example, the width of the resin wall 43 of the first resin body 41 at the outer periphery of the first coil portions 51 and 61 can be set to 20 μm. Similarly, the resin wall 43 of the resin body 42 (second resin body) provided on the lower surface 30d of the substrate 30 covers the second coil portions 52 and 62 at an inner periphery, an outer periphery, and between lines thereof. In the present embodiment, a width of the resin wall 43 of the second resin body 42 at the outer periphery and the inner periphery of the second coil portions 52 and 62 is designed to be wider than a width of the resin wall 43 of the second resin body 42 between the lines of the second coil portions 52 and 62. The width of the resin wall 43 of the second resin body 42 at the outer periphery of the second coil portions 52 and 62 may be wider than or the same as the width of the resin wall 43 of the second resin body 42 at the inner periphery. As an example, the width of the resin wall 43 of the second resin body 42 at the outer periphery of the second coil portions 52 and 62 can be set to 20 μm. Each of the resin bodies 41 and 42 is made of a non-magnetic resin material and is a thick-film resist patterned by known photolithography. The conductor 44 of the coil body 40 can be formed by plating in a state where a growth region is defined by the resin walls 43 of the respective resin bodies 41 and 42. In the present embodiment, a cross-sectional dimension (for example, a width or a height in a rectangular cross section) of the conductor 44 constituting the coil body 40 is substantially uniform over the entire length of the coil body. The cross-sectional dimension of the conductor 44 is, for example, 175 μm in height and 90 μm in width. An insulating coating 45 is provided on a surface of the conductor 44, and insulation between the conductor 44 and the magnetic powder-containing resin constituting the element body 10 is achieved.

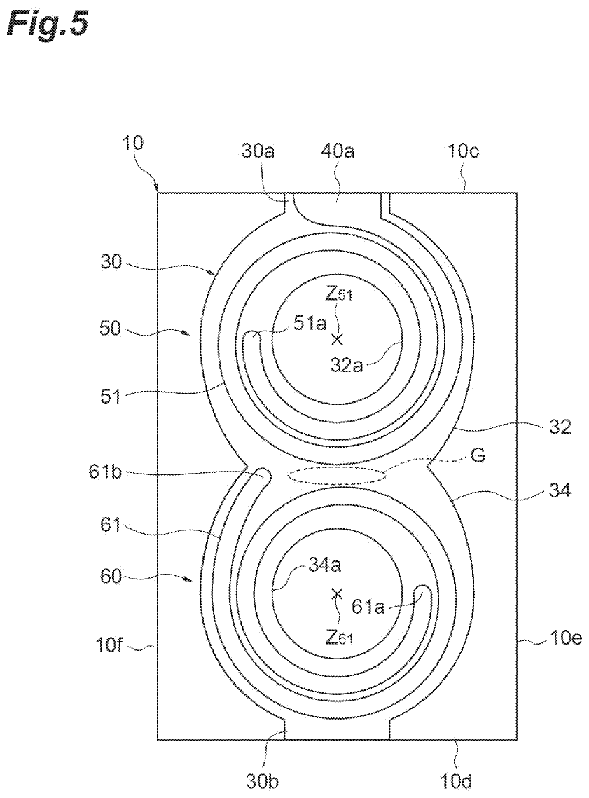

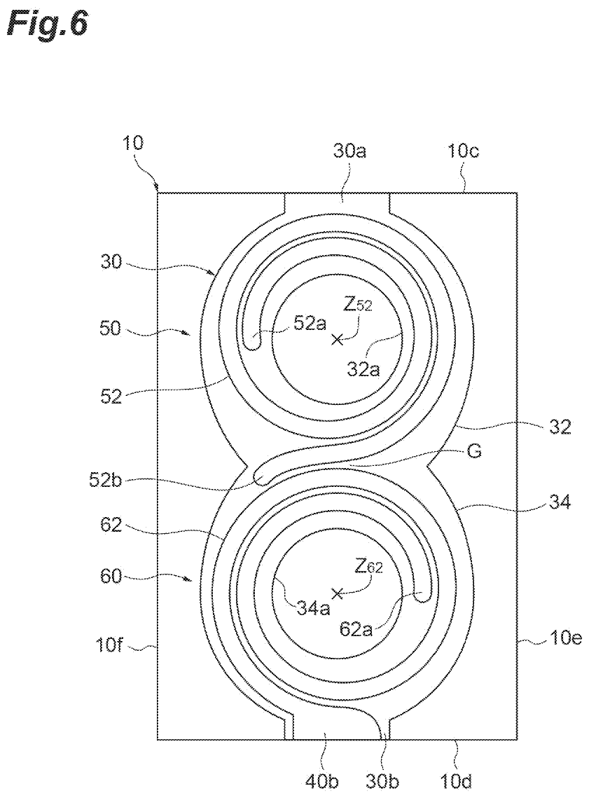

Next, the configuration of the first coil 50 and the second coil 60 will be described in more detail with reference to FIGS. 5 and 6. Both FIG. 5 and FIG. 6 show a positional relationship among the substrate 30, the first coil 50, and the second coil 60 when viewed from the main surface 10a side of the element body 10.

The first coil 50 is located on the end surface 10c side of the element body 10. As shown in FIG. 5, the first coil portion 51 of the first coil 50 is a planar spiral conductor pattern of a single-layer structure wound by about 1.5 to 2 turns around a coil axis Z51. The first portion 32 of the substrate 30 that overlaps with the first coil portion 51 has a substantially annular shape and has a through-hole 32a through which a periphery of the coil axis Z51 of the first coil portion 51 passes. The first coil portion 51 is wound clockwise from an outer turn toward an inner turn. An outer end portion of the first coil portion 51 constitutes an end portion 40a of the coil body 40. An inner end portion 51a of the first coil portion 51 is connected to a first through-hole conductor 33 provided through a portion of the substrate 30 that overlaps with the inner end portion 51a. The inner end portion 51a of the first coil portion 51 is located at an edge of the through-hole 32a of the first portion 32.

The second coil 60 is located on the end surface 10d side of the element body 10. As shown in FIG. 5, the first coil portion 61 of the second coil 60 is a planar spiral conductor pattern of a single-layer structure wound by about 1.5 to 2 turns around a coil axis Z61. The second portion 34 of the substrate 30 that overlaps with the first coil portion 61 has a substantially annular shape and has a through-hole 34a through which a periphery of the coil axis Z61 of the first coil portion 61 passes. The first coil portion 61 is wound clockwise from an inner turn toward an outer turn. An inner end portion 61a of the first coil portion 61 is connected to a first through-hole conductor 35 provided through a portion of the substrate 30 that overlaps with the inner end portion 61a. The inner end portion 61a of the first coil portion 61 is located at an edge of the through-hole 34a of the second portion 34. An outer end portion 61b of the first coil portion 61 extends toward the end surface 10c side of the element body 10 and is connected to a second through-hole conductor 37 provided through a portion of the substrate 30 that overlaps with the outer end portion 61b. In the present embodiment, the outer end portion 61b of the first coil portion 61 is located near a side surface 10f in the vicinity of a boundary between the first portion 32 and the second portion 34 on the upper surface 30c of the substrate 30.

On the upper surface 30c of the substrate 30, the first coil portion 51 of the first coil 50 and the first coil portion 61 of the second coil 60 are spaced apart and are not electrically connected on the upper surface 30c of the substrate 30. The first coil portion 51 of the first coil 50 and the first coil portion 61 of the second coil 60 are asymmetrical, and for example, do not have a line-symmetrical relationship with respect to the reference line L1, and do not have a point-symmetrical relationship with respect to a center of the element body 10 or a center of the substrate 30. The first coil portion 51 of the first coil 50 and the first coil portion 61 of the second coil 60 may have the same or different number of turns and conductor width. In the present embodiment, the coil axis Z51 of the first coil portion 51 and the coil axis Z61 of the first coil portion 61 are aligned in the long-side direction of the element body 10 (that is, the facing direction of the end surfaces 10c and 10d).

As shown in FIG. 6, the second coil portion 52 of the first coil 50 is a planar spiral conductor pattern of a single-layer structure wound by about 1.5 to 2 turns around a coil axis Z52. In the present embodiment, the coil axis Z52 of the second coil portion 52 coincides with the coil axis Z51 of the first coil portion 51. The second coil portion 52 is wound clockwise from an inner turn toward an outer turn. Therefore, in the first coil portion 51 and the second coil portion 52 of the first coil 50, when viewed from the main surface 10a side of the element body 10, a current flows in the same winding direction when a current flows. An inner end portion 52a of the second coil portion 52 is located at a position overlapping with the first through-hole conductor 33 on the lower surface 30d of the substrate 30, and is connected to the first through-hole conductor 33. An outer end portion of the second coil portion 52 extends toward the end surface 10d side of the element body 10 to a position overlapping with the second through-hole conductor 37 on the lower surface 30d of the substrate 30, and is connected to the second through-hole conductor 37.

The second coil portion 62 of the second coil 60 is a planar spiral conductor pattern of a single-layer structure wound by about 1.5 to 2 turns around a coil axis Z62. In the present embodiment, the coil axis Z62 of the second coil portion 62 coincides with the coil axis Z61 of the first coil portion 61. The second coil portion 62 is wound counterclockwise from an outer turn toward an inner turn. Therefore, in the first coil portion 61 and the second coil portion 62 of the second coil 60, when viewed from the main surface 10a side of the element body 10, a current flows in the same winding direction when a current flows. An inner end portion 62a of the second coil portion 62 is located at a position overlapping with the first through-hole conductor 35 on the lower surface 30d of the substrate 30, and is connected to the first through-hole conductor 35. An outer end portion 62b of the second coil portion 62 constitutes an end portion 40b of the coil body 40.

On the lower surface 30d of the substrate 30, the second coil portion 52 of the first coil 50 and the second coil portion 62 of the second coil 60 are spaced apart and are not electrically connected on the lower surface 30d of the substrate 30. The second coil portion 52 of the first coil 50 and the second coil portion 62 of the second coil 60 are asymmetrical, and for example, do not have a line-symmetrical relationship with respect to the reference line L1, and do not have a point-symmetrical relationship with respect to a center of the element body 10 or a center of the substrate 30. The second coil portion 52 of the first coil 50 and the second coil portion 62 of the second coil 60 may have the same or different number of turns and conductor width. In the present embodiment, the coil axis Z52 of the second coil portion 52 and the coil axis Z62 of the second coil portion 62 are aligned in the long-side direction of the element body 10 (that is, the facing direction of the end surfaces 10c and 10d).

Since the coil body 40 has the above-described configuration, when a voltage is applied between the pair of external terminals 20A and 20B and, for example, a current flows from the first external terminal 20A to the second external terminal 20B, the current from the first external terminal 20A flows through the first coil 50 of the coil body 40 and then flows through the second coil 60 to reach the second external terminal 20B. More specifically, the current from the first external terminal 20A sequentially flows through the first coil portion 51 and the second coil portion 52 of the first coil 50, and then sequentially flows through the first coil portion 61 and the second coil portion 62 of the second coil 60 to reach the second external terminal 20B. When the current flows in this manner, since a winding direction of the first coil 50 and a winding direction of the second coil 60 are opposite when viewed from the main surface 10a side of the element body 10, the current flows clockwise in the first coil 50, whereas the current flows counterclockwise in the second coil 60. As a result, a magnetic flux in a direction from the main surface 10a toward the main surface 10b is generated inside (inner core) of the first coil 50, and a magnetic flux in a direction from the main surface 10b toward the main surface 10a is generated inside (inner core) of the second coil 60. At this time, on the upper surface 30c of the substrate 30, since a voltage of the first coil portion 61 of the second coil 60 has dropped compared to the first coil portion 51 of the first coil 50, stray capacitance may be generated in a gap G between the first coil portions 51 and 61 mainly in the long-side direction of the element body 10. In the present embodiment, the gap G on the upper surface 30c of the substrate 30 is configured with the first resin body 41, and more specifically, is configured with the resin walls 43 of the first resin body 41 at the outer peripheries of the first coil portions 51 and 61. Also on the lower surface 30d of the substrate 30, since a voltage of the second coil portion 62 of the second coil 60 has dropped compared to the second coil portion 52 of the first coil 50, stray capacitance may be generated in a gap G between the second coil portions 52 and 62 mainly in the long-side direction of the element body 10. In the present embodiment, the gap G on the lower surface 30d of the substrate 30 is configured with the second resin body 42, and more specifically, is configured with the resin walls 43 of the second resin body 42 at the outer peripheries of the second coil portions 52 and 62.

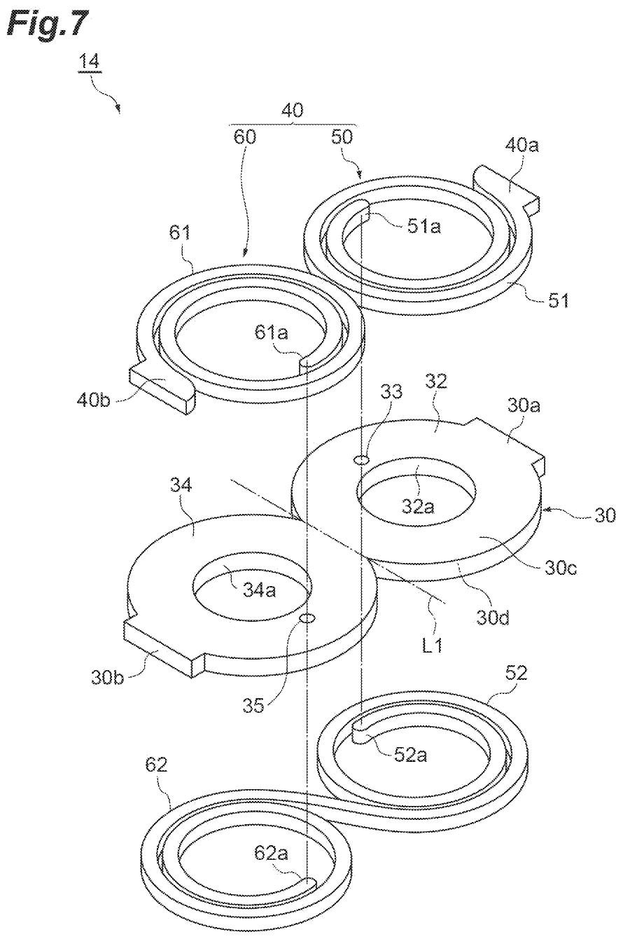

In the coil component 1, when considering a current path, only the second coil portion 52 of the first coil 50 is interposed between the adjacent first coil portion 51 of the first coil 50 and first coil portion 61 of the second coil 60 on the upper surface 30c of the substrate 30. On the other hand, in a configuration as shown in FIG. 7, where the outer end portions of the second coil portions of the first coil 50 and the second coil 60 are directly connected on the lower surface 30d of the substrate 30, when considering the current path, the second coil portion 62 of the second coil 60 is interposed in addition to the second coil portion 52 of the first coil 50 between the first coil portion 51 of the first coil 50 and the first coil portion 61 of the second coil 60, and as a result, a potential difference between the first coil portions 51 and 61 becomes relatively large, which may result in a relatively large stray capacitance between the first coil portions 51 and 61. In the coil component 1, because the outer end portion 52b of the second coil portion 52 of the first coil 50 provided on the lower surface 30d of the substrate 30 and the outer end portion 61b of the first coil portion 61 of the second coil 60 provided on the upper surface 30c of the substrate 30 are connected via the second through-hole conductor 37, the potential difference between the first coil portions 51 and 61 is reduced, thereby suppressing a situation in which a large stray capacitance is generated in the gap G between the first coil portions 51 and 61.

Note that, when considering a current path, only the first coil portion 61 of the second coil 60 is interposed between the adjacent second coil portion 52 of the first coil 50 and second coil portion 62 of the second coil 60 on the lower surface 30d of the substrate 30. Therefore, the potential difference between the second coil portions 52 and 62 is comparable to the potential difference between the first coil portions 51 and 61 described above, and in the coil component 1, a situation in which a large stray capacitance is generated is also suppressed in the gap G between the second coil portions 52 and 62.

In the coil component 1 in which the stray capacitance is thus reduced, the self-resonant frequency is increased and high impedance can be realized from a low band to a high band, and therefore, by applying the coil component 1 to PoC technology, high signal transmission characteristics can be realized.

Further, in the coil component 1, one end portion 40a of the coil body 40 is exposed on the end surface 10c of the element body 10 on a side far from the mounting surface 10b with respect to the substrate 30 (that is, on the upper surface 30c of the substrate 30), and the other end portion 40b is exposed on the end surface 10d of the element body 10 on a side close to the mounting surface 10b with respect to the substrate 30 (that is, on the lower surface 30d of the substrate 30). In this case, even if only the coil body 40 is inverted front to back during a manufacturing stage of the coil component 1 (that is, the end portion 40a is on the side close to the mounting surface 10b with respect to the substrate 30, and the end portion 40b is on the side far from the mounting surface 10b with respect to the substrate 30), a sum of a distance from the mounting surface 10b to the end portion 40a on the end surface 10c and a distance from the mounting surface 10b to the end portion 40b on the end surface 10d is substantially the same between the coil component 1 with the inverted coil body 40 and the coil component 1 without inversion. On the other hand, in a configuration as shown in FIG. 7 where both end portions 40a and 40b of the coil body 40 are exposed on both end surfaces 10c and 10d of the element body 10 on a side far from the mounting surface 10b with respect to the substrate 30 (that is, on the upper surface 30c of the substrate 30), if only the coil body 40 is inverted front to back during the manufacturing stage of the coil component 1 (that is, both end portions 40a and 40b are on the side close to the mounting surface 10b with respect to the substrate 30), a sum of a distance from the mounting surface 10b to the end portion 40a on the end surface 10c and a distance from the mounting surface 10b to the end portion 40b on the end surface 10d becomes significantly shorter in the coil component 1 with the inverted coil body 40 compared to the coil component 1 without inversion. Therefore, variations in resistance values at the pair of external terminals 20A and 20B may occur between the coil component 1 with the inverted coil body 40 and the coil component 1 without inversion.

The gap G may be filled with a resist resin (insulating resin) that constitutes the resin bodies 41 and 42, may be filled with a magnetic material that constitutes the element body 10, or may be filled with the resist resin that constitutes the resin bodies 41 and 42 and the magnetic material that constitutes the element body 10. When the gap G is filled only with the resist resin constituting the resin bodies 41 and 42, since a dielectric constant of the resist resin is lower than a dielectric constant of the magnetic material, a reduction in stray capacitance in the gap G is achieved, and a high breakdown voltage can be realized between the first coil portions 51 and 61 and between the second coil portions 52 and 62.

When filling the gap G only with the resist resin constituting the resin bodies 41 and 42, the width of the resin wall 43 of the first resin body 41 at the outer peripheries of the first coil portions 51 and 61 and the width of the resin wall 43 of the second resin body 42 at the outer peripheries of the second coil portions 52 and 62 may be increased, and in this case, the width of the resin wall 43 of the first resin body 41 at the outer peripheries of the first coil portions 51 and 61 and the width of the resin wall 43 of the second resin body 42 at the outer peripheries of the second coil portions 52 and 62 become wider than the width of the resin walls 43 of the first resin body 41 and the second resin body 42 at the inner peripheries. While making the width of the resin wall 43 of the first resin body 41 at the outer peripheries of the first coil portions 51 and 61 and the width of the resin wall 43 of the second resin body 42 at the outer peripheries of the second coil portions 52 and 62 wider than the width of the resin walls 43 of the first resin body 41 and the second resin body 42 at the inner peripheries, the magnetic material constituting the element body 10 may be interposed between the resin walls 43 of the first resin body 41 at the outer peripheries of the first coil portions 51 and 61, and the magnetic material constituting the element body 10 may be interposed between the resin walls 43 of the second resin body 42 at the outer peripheries of the second coil portions 52 and 62.

Note that, when viewed from the main surface 10a side of the element body 10, the coil axes Z52 and Z62 of the second coil portions 52 and 62 may be shifted from the coil axes Z51 and Z61 of the first coil portions 51 and 61. For example, by shifting the coil axis Z51 of the first coil portion 51 of the first coil 50 toward the end surface 10c side with respect to the coil axis Z52 of the second coil portion 52, the gap G between the first coil portions 51 and 61 is widened, and a reduction in stray capacitance can be achieved. Also by shifting the coil axis Z61 of the first coil portion 61 of the second coil 60 to the end surface 10d with respect to the coil axis Z62 of the second coil portion 62, the gap G between the first coil portions 51 and 61 is widened, and a reduction in stray capacitance can be achieved.

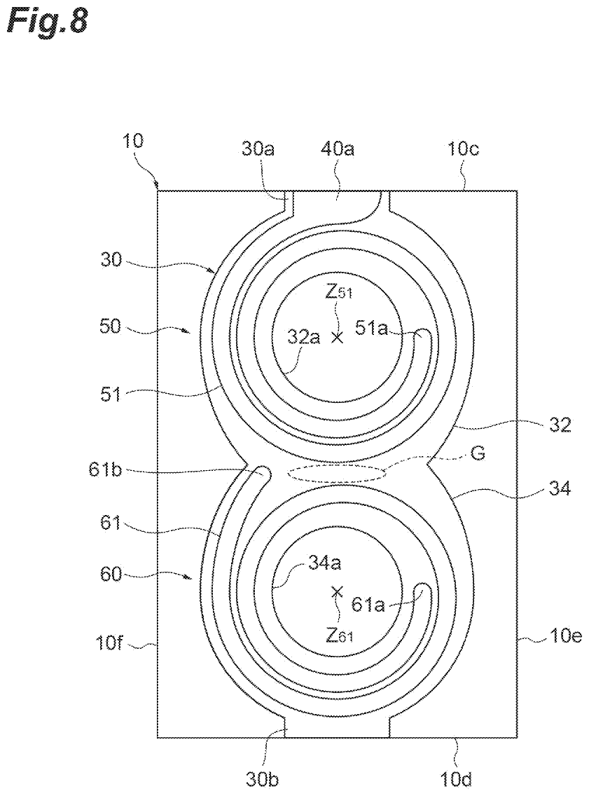

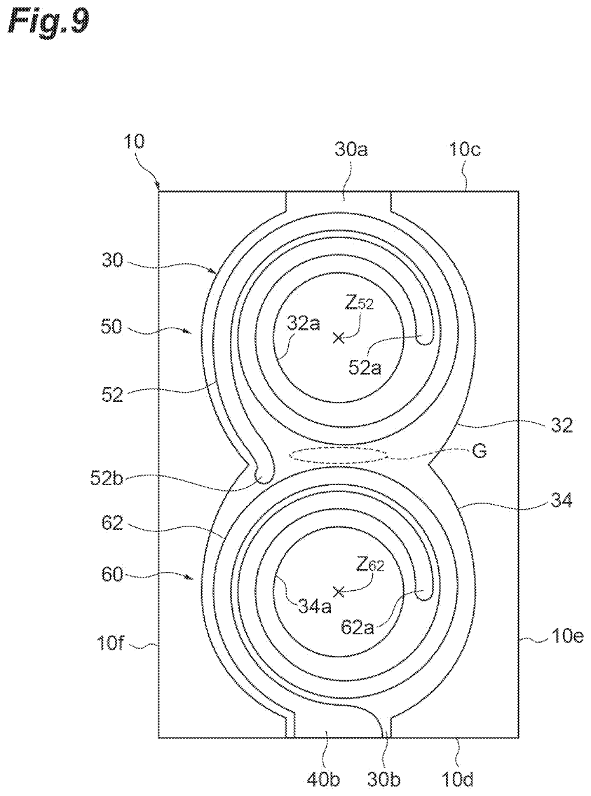

In the above-described embodiment, the winding direction of the first coil 50 and the winding direction of the second coil 60 were opposite when viewed from the main surface 10a side of the element body 10, but as in the forms shown in FIGS. 8 and 9, the winding direction of the first coil 50 and the winding direction of the second coil 60 may be the same.

In this case, as shown in FIG. 8, when viewed from the main surface 10a side of the element body 10, the first coil portion 51 of the first coil 50 is wound counterclockwise from an outer turn toward an inner turn. Similarly, the first coil portion 61 of the second coil 60 is also wound counterclockwise from an outer turn toward an inner turn when viewed from the main surface 10a side of the element body 10. Further, as shown in FIG. 9, when viewed from the main surface 10a side of the element body 10, the second coil portion 52 of the first coil 50 is wound counterclockwise from an inner turn toward an outer turn. The second coil portion 62 of the second coil 60 is wound counterclockwise from an inner turn toward an outer turn when viewed from the main surface 10a side of the element body 10.

In the form shown in FIGS. 8 and 9, when a voltage is applied between the pair of external terminals 20A and 20B and, for example, a current flows from the first external terminal 20A to the second external terminal 20B, since the winding direction of the first coil 50 and the winding direction of the second coil 60 are the same when viewed from the main surface 10a side of the element body 10, the current flows counterclockwise in the first coil 50 and the second coil 60. As a result, a magnetic flux in a direction from the main surface 10b toward the main surface 10a is generated inside (inner core) of both the first coil 50 and the second coil 60. Even in such a form, because the outer end portion 52b of the second coil portion 52 of the first coil 50 provided on the lower surface 30d of the substrate 30 and the outer end portion 61b of the first coil portion 61 of the second coil 60 provided on the upper surface 30c of the substrate 30 are connected via the second through-hole conductor 37, when considering a current path, only the second coil portion 52 of the first coil 50 is interposed between the adjacent first coil portion 51 of the first coil 50 and first coil portion 61 of the second coil 60 on the upper surface 30c of the substrate 30, and thus the potential difference between the first coil portions 51 and 61 is reduced, thereby suppressing a situation in which a large stray capacitance is generated in the gap G between the first coil portions 51 and 61.

Also in the form shown in FIGS. 8 and 9, when considering a current path, only the first coil portion 61 of the second coil 60 is interposed between the adjacent second coil portion 52 of the first coil 50 and second coil portion 62 of the second coil 60 on the lower surface 30d of the substrate 30, and therefore the potential difference between the second coil portions 52 and 62 is also reduced, thereby also suppressing a situation in which a large stray capacitance is generated in the gap G between the second coil portions 52 and 62.

What is claimed is:

1. A coil component, comprising:
an element body;
a substrate provided in the element body and having a first main surface and a second main surface parallel to each other;
a coil body provided in the element body, the coil body having a first coil and a second coil arranged in a first direction, each of the first coil and the second coil including a first coil portion spirally wound on the first main surface of the substrate, a second coil portion spirally wound on the second main surface of the substrate, and a through-hole conductor provided through the substrate to electrically connect inner end portions of the first coil portion and the second coil portion to each other; and
a second through-hole conductor provided through the substrate to electrically connect an outer end portion of the second coil portion of the first coil and an outer end portion of the first coil portion of the second coil to each other.

2. The coil component according to claim 1, wherein the element body includes a magnetic material.

3. The coil component according to claim 1, further comprising:
a first resin body provided on the first main surface of the substrate and including a resin wall covering the first coil portion at an inner periphery, an outer periphery, and between windings of the first coil portion; and
a second resin body provided on the second main surface of the substrate and including a resin wall covering the second coil portion at an inner periphery, an outer periphery, and between windings of the second coil portion,
wherein, with respect to a length in the first direction, a length of the resin wall at the outer periphery is longer than a length of the resin wall at the inner periphery of the first coil portion of the first coil in the first resin body.

4. The coil component according to claim 1, wherein a gap in the first direction between the first coil portion of the first coil and the first coil portion of the second coil is filled with an insulating resin.

5. The coil component according to claim 1,
wherein the element body has a pair of main surfaces facing each other, and a first end surface and a second end surface connecting the pair of main surfaces and parallel to each other,
the substrate extends parallel to the main surfaces of the element body, and the first main surface and the second main surface are parallel to the main surfaces of the element body,
the coil component further comprising:
a first external terminal provided on the first end surface of the element body and connected to an outer end portion of the first coil portion of the first coil exposed from the first end surface; and
a second external terminal provided on the second end surface of the element body and connected to an outer end portion of the second coil portion of the second coil exposed from the second end surface.
